(19) United States
(12) Patent Application Publication
(10) Pub. No.: US 2015/0055527 A1
(43) Pub. Date: Feb. 26, 2015

(54) DEVICES AND METHODS FOR FACILITATING POWER SAVINGS BY OPTIMIZED DATA BLOCK DECODES IN WIRELESS COMMUNICATIONS SYSTEMS

(71) Applicant: QUALCOMM INCORPORATED, SAN DIEGO, CA (US)

(72) Inventors: Abeezar A. BURHAN, Middlesex (GB); Divaydeep Sikri, Farnborough (GB)

(73) Assignee: QUALCOMM INCORPORATED, SAN DIEGO, CA (US)

(21) Appl. No.: 14/010,146

(22) Filed: Aug. 26, 2013

(51) Int. Cl. H04W 52/02

(52) U.S. Cl. CPC H04W 52/0209
USPC 370/311

(57) ABSTRACT

Access terminals are adapted to facilitate data block decoding, where a header may be decoded while a data payload is not decoded. According to one example, an access terminal can convey information from an upper layer of a protocol stack to a physical layer of the protocol stack. The conveyed information can be adapted to cause the physical layer to bypass decoding a data payload for one or more received data blocks. On receipt of a data block, a header of the received data block can be decoded at the physical layer without decoding a data payload for the received data block. Other aspects, embodiments, and features are also included.

### TECHNICAL FIELD

The technology discussed below relates generally to wireless communications, and more specifically, to methods and devices capable of saving power by implementing optimized decoding of received data blocks during wireless communications.

### BACKGROUND

Wireless communications systems are widely deployed to provide various types of communication content such as voice, video, packet data, messaging, broadcast, and so on. These systems may be accessed by various types of devices (e.g., phones and smartphones) adapted to facilitate wireless communications. In some situations, multiple devices can share available system resources (e.g., time, frequency, and power) enabling many users to use the system. Examples of such wireless communications systems include code-division multiple access (CDMA) systems, time-division multiple access (TDMA) systems, frequency-division multiple access (FDMA) systems and orthogonal frequency-division multiple access (OFDMA) systems.

Multiple types of devices are adapted to utilize such wireless communications systems. These devices may be generally referred to as access terminals. Access terminals are becoming increasingly popular, with consumers often using power-hungry applications that run on such access terminals. Access terminals are typically battery-powered and the amount of power a battery can provide between charges is generally limited. Accordingly, features may be desirable to improve the battery life between charges in access terminals.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate power conservation by optimizing decoding operations for received data blocks in wireless communications systems.

According to at least one aspect of the disclosure, access terminals may include a communications interface adapted to receive encoded data blocks. A processing circuit may be coupled to the communications interface, and the processing circuit may be adapted to implement a protocol stack comprising a physical layer and an upper layer. The processing circuit may be adapted to provide information from the upper layer of the protocol stack to the physical layer of the protocol stack, where the information is adapted to cause the physical layer to bypass decoding a data payload for one or more data blocks received via the communications interface. The processing circuit may further be adapted to decode, at the physical layer, a header of a received data block without decoding a data payload for the received data block in response to the information provided from the upper layer.

Further aspects provide methods operational on access terminals and/or access terminals including means to perform such methods. One or more examples of such methods may include conveying information from an upper layer of a protocol stack to a physical layer of the protocol stack, wherein the information is adapted to cause the physical layer to bypass decoding a data payload for one or more received data blocks. A data block may be received, and the physical layer may decode a header of the received data block without decoding a data payload for the received data block in response to the information conveyed from the upper layer.

Still further aspects include processor-readable storage mediums comprising programming executable by a processing circuit. According to one or more examples, such programming may be adapted for causing the processing circuit to provide information from an upper layer of a protocol stack to a physical layer of the protocol stack, where the information is adapted to cause the physical layer to bypass decoding a data payload for one or more received data blocks. The programming may further be adapted for causing the processing circuit to decode, at the physical layer, a header of a received data block without decoding a data payload for the received data block in response to the information provided from the upper layer.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram of a network environment in which one or more aspects of the present disclosure may find application.

FIG. 2 is a block diagram illustrating select components of the wireless communication system of FIG. 1 according to some embodiments.

FIG. 3 is a block diagram illustrating select components of an access terminal according to some embodiments.

FIG. 4 is a block diagram illustrating an example of a protocol stack architecture which may be implemented by an access terminal according to some embodiments.

FIG. 5 is a flow diagram illustrating a method operational on an access terminal according to some embodiments.

FIG. 6 is a flow diagram illustrating an example of an algorithm that may be implemented by an upper layer of the protocol stack according to some embodiments.

FIG. 7 is a flow diagram illustrating an example of an algorithm that may be implemented by the physical layer of the protocol stack according to some embodiments.

FIG. 8 is a flow diagram illustrating another example of an algorithm that may be implemented by an upper layer of the protocol stack according to some embodiments.

FIG. 9 is a flow diagram illustrating another example of an algorithm that may be implemented by the physical layer of the protocol stack according to some embodiments.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of telecommunication systems, network architectures, and communication standards. Certain aspects of the disclosure are described below for 3rd Generation Partnership Project (3GPP) protocols and systems, and related terminology may be found in much of the following description. However, those of ordinary skill in the art will recognize that one or more aspects of the present disclosure may be employed and included in one or more other wireless communication protocols and systems.

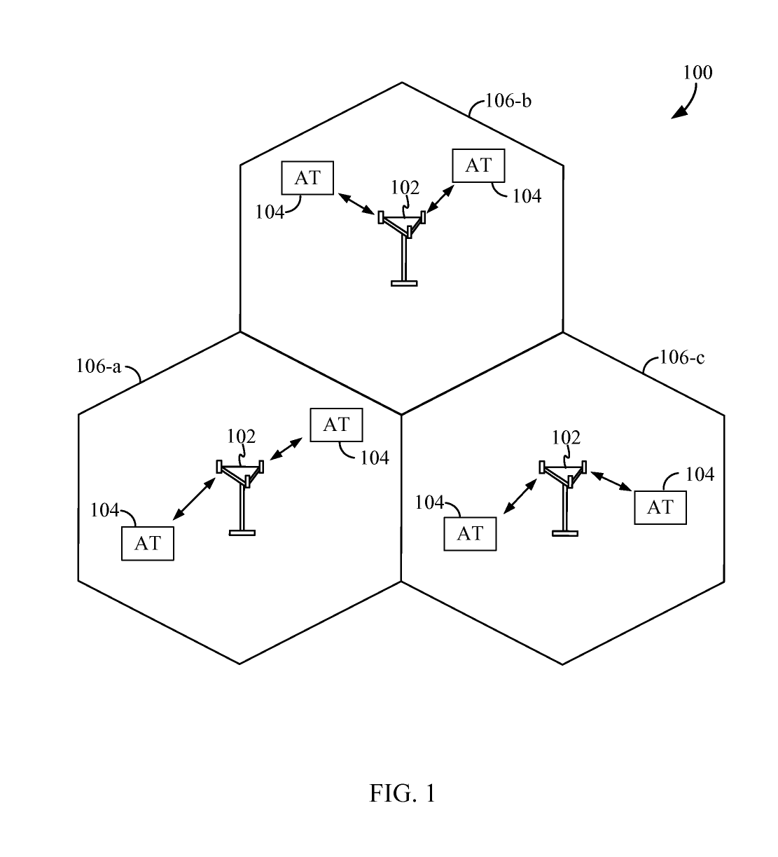

Referring now to FIG. 1, a block diagram of a network environment in which one or more aspects of the present disclosure may find application is illustrated. The wireless communications system 100 is adapted to facilitate wireless communication between one or more base stations 102 and access terminals 104. The base stations 102 and access terminals 104 may be adapted to interact with one another through wireless signals. In some instances, such wireless interaction may occur on multiple carriers (waveform signals of different frequencies). Each modulated signal may carry control information (e.g., pilot signals), overhead information, data, etc.

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. Such a base station 102 may also be referred to by those skilled in the art as a base transceiver station (BTS), a radio base station, a radio transceiver, a transceiver function, a basic service set (BSS), and extended service set (ESS), a node B, a femto cell, a pico cell, or some other suitable terminology.

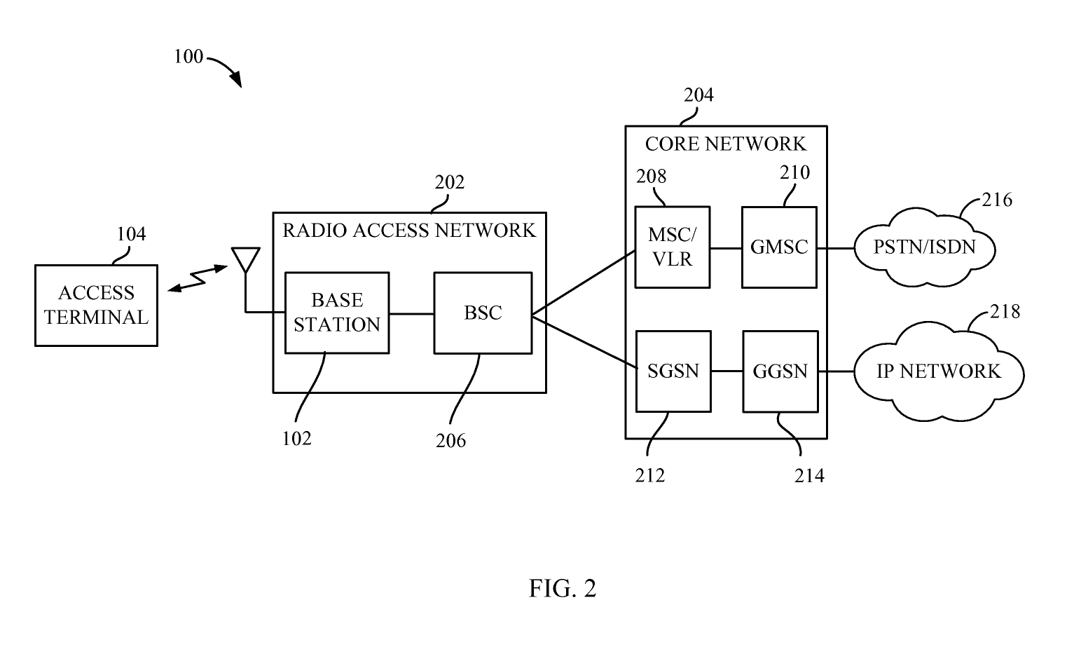

The base stations 102 are configured to communicate with the access terminals 104 under the control of a base station controller (see FIG. 2). Each of the base station 102 sites can provide communication coverage for a respective geographic area. The coverage area 106 for each base station 102 here is identified as cells 106-a, 106-b, or 106-c. The coverage area 106 for a base station 102 may be divided into sectors (not shown, but making up only a portion of the coverage area). In various examples, the system 100 may include base stations 102 of different types.

One or more access terminals 104 may be dispersed throughout the coverage areas 106. Each access terminal 104 may communicate with one or more base stations 102. An access terminal 104 may generally include one or more devices that communicate with one or more other devices through wireless signals. Such an access terminal 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. An access terminal 104 may include a mobile terminal and/or an at least substantially fixed terminal Examples of an access terminal 104 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, entertainment device, meter, router, and/or other communication/computing device which communicates, at least partially, through a wireless or cellular network.

Turning to FIG. 2, a block diagram illustrating select components of the wireless communication system 100 is depicted according to at least one example. As illustrated, the base stations 102 are included as at least a part of a radio access network (RAN) 202. The radio access network (RAN) 202 is generally adapted to manage traffic and signaling between one or more access terminals 104 and one or more other network entities, such as network entities included in a core network 204. The radio access network 202 may, according to various implementations, be referred to by those skill in the art as a base station subsystem (BSS), an access network, a GSM Edge Radio Access Network (GERAN), a UMTS Terrestrial Radio Access Network (UTRAN), etc.

In addition to one or more base stations 102, the radio access network 202 can include a base station controller (BSC) 206, which may also be referred to by those of skill in the art as a radio network controller (RNC). The base station controller 206 is generally responsible for the establishment, release, and maintenance of wireless connections within one or more coverage areas associated with the one or more base stations 102 which are connected to the base station controller 206. The base station controller 206 can be communicatively coupled to one or more nodes or entities of the core network 204.

The core network 204 is a portion of the wireless communications system 100 that provides various services to access terminals 104 that are connected via the radio access network 202. The core network 204 may include a circuit-switched (CS) domain and a packet-switched (PS) domain. Some examples of circuit-switched entities include a mobile switching center (MSC) and visitor location register (VLR), identified as MSC/VLR 208, as well as a Gateway MSC (GMSC) 210. Some examples of packet-switched elements include a Serving GPRS Support Node (SGSN) 212 and a Gateway GPRS Support Node (GGSN) 214. Other network entities may be included, such as an EIR, a HLR, a VLR and/or a AuC, some or all of which may be shared by both the circuit-switched and packet-switched domains. An access terminal 104 can obtain access to a public switched telephone network (PSTN) 216 via the circuit-switched domain, and to an IP network 218 via the packet-switched domain.

Access terminals 104 operating in the communications system 100 may receive downlink transmissions of data blocks over an air interface. A data block typically includes a header, a data payload, as well as other information, such as a checksum. This information is typically convolutionally encoded, interleaved, and then modulated to a plurality of RF bursts according to one or more predefined schemes. When RF bursts for a data block are received at an access terminal 104, the access terminal 104 will demodulate, de-interleave, and then decode both the header and the payload of the data block according to the scheme or schemes employed. Typically, these steps are performed at the physical layer 202, and the decoded data block is provided to the data link layer 304 for further processing.

Often, an access terminal 104 receives data blocks through a downlink Temporary Block Flow (TBF) established between the access terminal 104 and a base station 102. A TBF is a logical connection used in GPRS/EGPRS to support the unidirectional transfer of lower layer compatibility (LLC) protocol data units (PDUs) on packet data physical channels (PDCHs). In a typical GPRS/EGPRS system, the network establishes a downlink TBF to transfer data blocks in the downlink direction. TBFs are typically short-lived and are generally only active during data transfers. Furthermore, such systems may encode the header and payload of a data block separately. The header can be protected with a higher coding rate.

During a downlink TBF, various situations may arise in which an access terminal 104 will decode both the header and payload of a received data block even though the payload may be irrelevant or unnecessary. For example, the base station controller 206 may request that a downlink TBF be closed, such as after the last data block has been successfully sent to the access terminal 104. In such instances, a protocol guard timer, identified in GPRS/EGPRS systems as timer T3192, may be started. During the duration of this timer (typical between 0 ms and 1500 ms, and commonly 500 ms), the access terminal 104 may receive transmissions from the network, such as a Poll instructing the access terminal 104 to restart the timer. Although such transmissions (e.g., a Poll) from the network comes in the header of a data block, the access terminal 104 will typically also decode the payload of the received data block.

In another example, the base station controller 206 may assign parameters for particular data blocks. For example, the network may indicate that a sequence of data blocks will be sent which are numbered within a specific window or range (e.g., data blocks with sequence numbers x through y). If one or more data blocks are not successfully received by the access terminal 104, the network will resend the unsuccessful data blocks. Because of the round-trip-delay, however, it is possible for the access terminal 104 to successfully receive one or more data blocks that the network thinks were unsuccessful. As a result, the network may resend a data block that was already successfully received by the access terminal 104. In other instances, the network may purposefully resend a previously successful data block to keep the downlink TBF active. Although the access terminal 104 will ultimately discard a resent data block that was successfully received earlier, the access terminal 104 will typically still decode both the header and payload of the resent data block.

As a result of such examples, as well as other situations, the access terminal 104 may be wasting power by decoding the data payload that either includes no relevant data or includes data that will just be discarded. Furthermore, in an access terminal 104 that uses multiple SIM subscriptions, the unnecessary reception and decode of the data payload may also result in cancellation of transmit slots for the other subscription.

According to one or more aspects of the present disclosure, access terminals are adapted to bypass decoding the data payload of one or more data blocks. In some scenarios, an upper layer of a protocol stack can be adapted to communicate with a physical layer of the protocol stack in such a way as to enable the physical layer to decode a header without decoding a data payload for one or more data blocks.

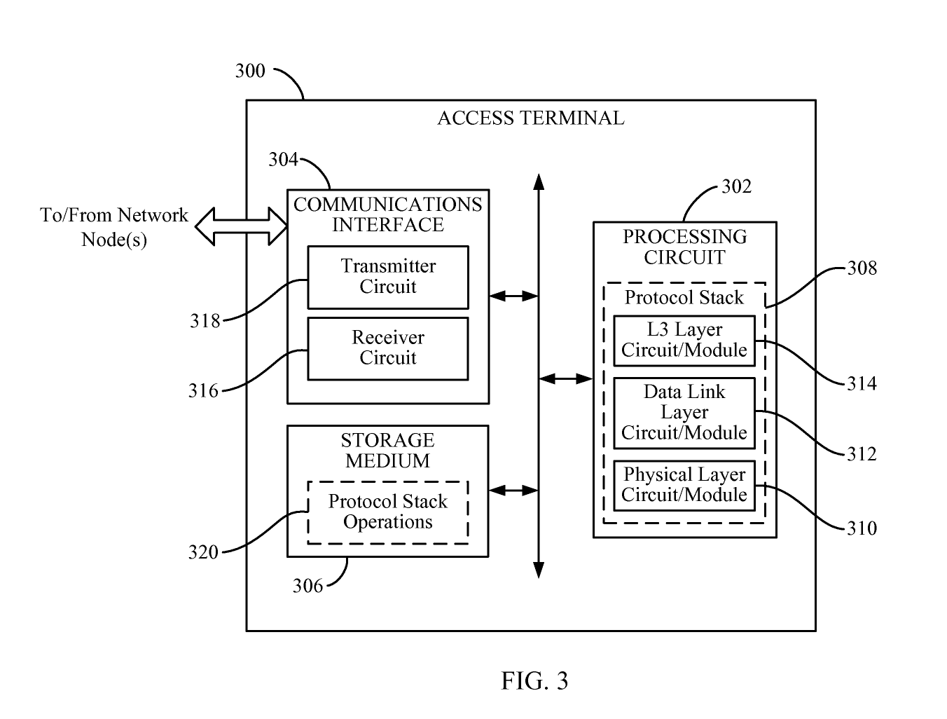

Turning to FIG. 3, a block diagram is shown illustrating select components of an access terminal 300 according to at least one example of the present disclosure. The access terminal 300 includes a processing circuit 302 coupled to or placed in electrical communication with a communications interface 304 and a storage medium 306.

The processing circuit 302 is arranged to obtain, process and/or send data, control data access and storage, issue commands, and control other desired operations. The processing circuit 302 may include circuitry adapted to implement desired programming provided by appropriate media in at least one example. For example, the processing circuit 302 may be implemented as one or more processors, one or more controllers, and/or other structure configured to execute executable programming. Examples of the processing circuit 302 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 302 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 302 are for illustration and other suitable configurations within the scope of the present disclosure are also contemplated.

The processing circuit 302 is adapted for processing, including the execution of programming, which may be stored on the storage medium 306. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

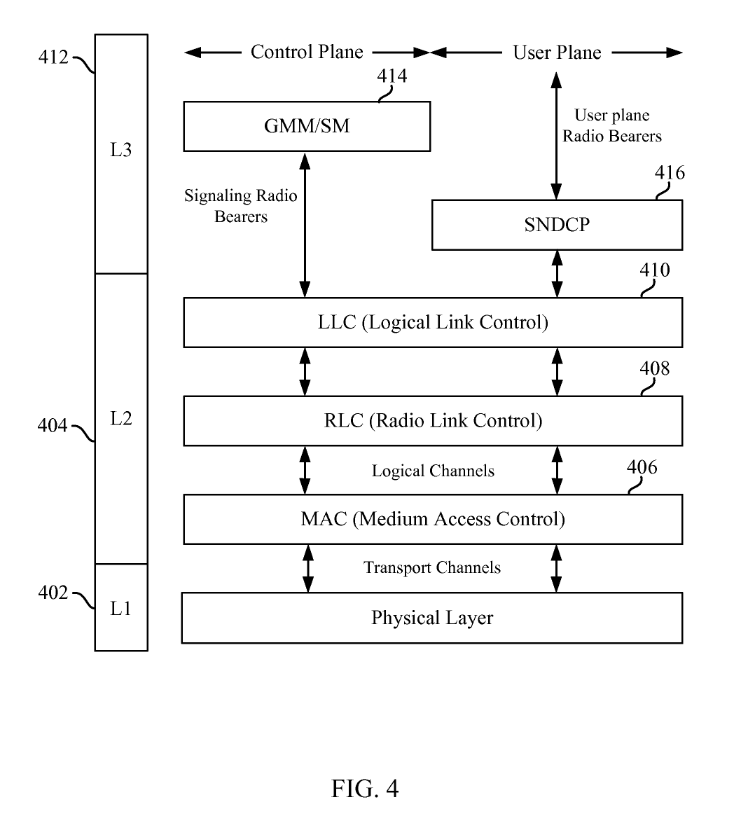

According to an aspect of the present disclosure, the processing circuit 302 is adapted to implement, in combination with the storage medium 306, a protocol stack 308. A protocol stack is typically employed for facilitating the communication of data between the access terminal 300 and one or more network nodes of a wireless communication system. A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 4 is a block diagram illustrating an example of a protocol stack architecture which may be implemented by the access terminal 300. The protocol stack architecture of FIG. 4 is shown to generally include three layers: Layer 1 (L1), Layer 2 (L2), and Layer 3 (L3). In the illustrated example, the user plane (or data plane) carries user traffic (e.g., voice services, data services), while the control plane carries control information (e.g., signaling).

Layer 1 402 is the lowest layer and implements various physical layer signal processing functions. Layer 1 402 is also referred to herein as the physical layer 402. This physical layer 402 provides for the transmission and reception of radio signals via the communications interface 304 between the access terminal 300 and a one or more network nodes.

The data link layer, called layer 2 or the L2 layer, 404 is above the physical layer 402 and is responsible for delivery of signaling messages generated by Layer 3. The data link layer 404 makes use of the services provided by the physical layer 402. The data link layer 404 may include various sublayers, including a Medium Access Control (MAC) sublayer 406, a Radio Link Control (RLC) sublayer 408, and a Logical Link Control (LLC) sublayer 410.

The MAC sublayer 406 is the lower sublayer of the data link layer 404. The MAC sublayer 406 implements the medium access protocol and is responsible for transport of higher layers' protocol data units using the services provided by the physical layer 402. The MAC sublayer 406 may manage the access of data from the higher layers to the shared air interface by providing multiplexing between logical and transport channels.

The RLC sublayer 408 provides segmentation and reassembly of upper layer data packets, retransmission of lost data packets, and reordering of data packets to compensate for out-of-order reception. The RLC sublayer 408 makes use of the services provided by the lower layers (e.g., layer 1 and the MAC sublayer).

The LLC sublayer 410 provides flow and sequence control, as well as error control. For example, the LLC sublayer 410 may be responsible for the framing of the user data packets and signaling messages of the mobility management and session management subsystem of the SGSN (e.g., SGSN 212 in FIG. 2). The LLC sublayer 410 may also ensure a reliable connection between the access terminal 104 and the SGSN (e.g., SGSN 212 in FIG. 2) by using an acknowledgement mechanism for correctly received blocks.

Layer 3 412, which may also be referred to as the L3 layer, makes use of the services provided by the data link layer 404. The L3 layer 412 includes a GPRS Mobility Management and Session Management (GMM/SM) layer 414 in the control plane and a Subnetwork Dependent Convergence Protocol (SNDCP) layer 416 in the user plane. The GMM/SM layer 414 is where signaling messages originate and terminate according to the semantics and timing of the communication protocol between a base station 102 and the access terminal 104. The SNDCP layer 416 provides multiplexing between different radio bearers and logical channels. The SNDCP layer 416 can also provide header compression for upper layer data packets to reduce radio transmission overhead, security by ciphering the data packets, and handover support for the access terminal 300 between base stations (e.g., base stations 102 in FIG. 1).

Although FIG. 4 illustrates various layers and sublayers of the protocol stack, it should be understood that access terminals 104 may employ additional, fewer, or different layers and/or sublayers according to various implementations.

Referring again to FIG. 3, the processing circuit 302 may, in one or more embodiments, include a physical layer circuit or module 310, a data link layer circuit or module 312 and/or a L3 layer circuit or module 314 for implementing respective layers of the protocol stack 308. For example, the physical layer circuit or module 310 may include circuitry and/or programming (e.g., protocol stack operations 312) adapted to implement the physical layer 402 in FIG. 4. Similarly, the data link layer circuit or module 312 may include circuitry and/or programming (e.g., protocol stack operations 312) adapted to implement the L2 or data link layer 404 in FIG. 4. Further, the L3 layer circuit or module 314 may include circuitry and/or programming (e.g., protocol stack operations 312) adapted to implement the L3 layer 412 in FIG. 4.

The communications interface 304 is configured to facilitate wireless communications of the access terminal 300. For example, the communications interface 304 may include circuitry and/or programming adapted to facilitate the communication of information bi-directionally with respect to one or more wireless network devices (e.g., network nodes). The communications interface 304 may be coupled to one or more antennas (not shown), and includes wireless transceiver circuitry, including at least one receiver circuit 316 and/or at least one transmitter circuit 318. In some embodiments, the communications interface 304 can be implemented in whole or in part with a wireless modem.

The storage medium 306 may represent one or more computer-readable, machine-readable, and/or processor-readable devices for storing programming, such as processor executable code or instructions (e.g., software, firmware), electronic data, databases, or other digital information. The storage medium 306 may also be used for storing data that is manipulated by the processing circuit 302 when executing programming. In at least one example, the storage medium 306 may represent a plurality of storage components, where each protocol stack circuit/module employs a respective storage component of the storage medium 306.

The storage medium 306 may include one or more of various available media that can be accessed by a general purpose or special purpose processor, including portable or fixed storage devices, optical storage devices, and various other mediums capable of storing, containing and/or carrying programming By way of example and not limitation, the storage medium 306 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 306 may be coupled to the processing circuit 302 such that the processing circuit 302 can read information from, and write information to, the storage medium 306. That is, the storage medium 306 can be coupled to the processing circuit 302 so that the storage medium 306 is at least accessible by the processing circuit 302, including examples where the storage medium 306 is integral to the processing circuit 302 and/or examples where the storage medium 306 is separate from the processing circuit 302 (e.g., resident in the access terminal 300, external to the access terminal 300, distributed across multiple entities).

Programming stored by the storage medium 306, when executed by the processing circuit 302, causes the processing circuit 302 to perform one or more of the various functions and/or process steps described herein. For example, the storage medium 306 may include protocol stack operations 320 adapted to cause an upper layer circuit or module 312 and/or 314 of the protocol stack 308 to provide information to the physical layer circuit/module 310. The provided information can be adapted to cause the physical layer circuit/module 310 to bypass decoding a data payload for one or more data blocks received via the communications interface 304. Thus, according to one or more aspects of the present disclosure, the processing circuit 302 is adapted to perform (in conjunction with the storage medium 306) any or all of the processes, functions, steps and/or routines for any or all of the access terminals (e.g., access terminal 104, access terminal 300) described herein. As used herein, the term “adapted” in relation to the processing circuit 302 may refer to the processing circuit 302 being one or more of configured, employed, implemented, and/or programmed (in conjunction with the storage medium 306) to perform a particular process, function, step and/or routine according to various features described herein.

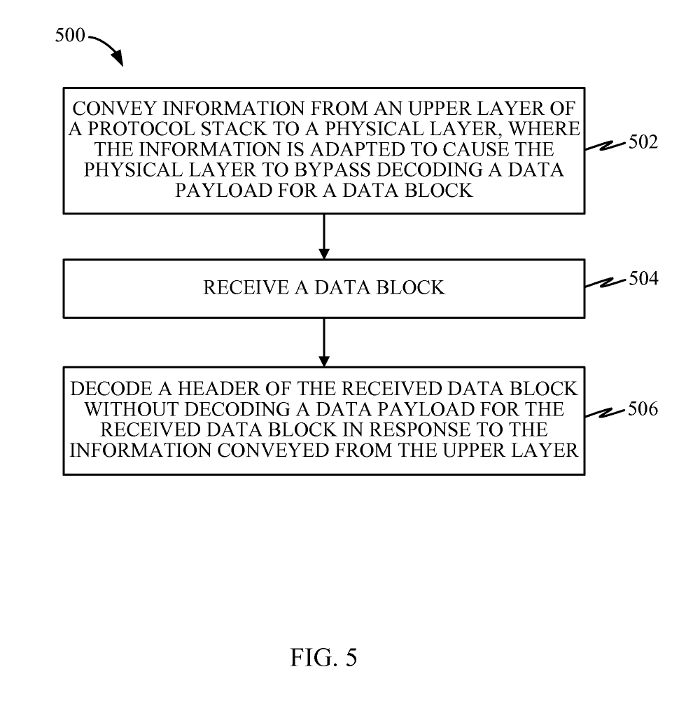

FIG. 5 is a flow diagram illustrating at least one example of a method 500 operational on an access terminal, such as the access terminal 300. Referring to FIGS. 3 and 5, an access terminal 300 can convey information from an upper layer of a protocol stack to the physical layer at step 502. The information conveyed to the physical layer can be adapted to cause the physical layer to bypass decoding a data payload for a received data block. The upper layer may be any one or more layers of the protocol stack 308 located above the physical layer. In at least one example, an upper layer circuit (e.g., the data link layer circuit 312 and/or the L3 layer circuit 314) executing the protocol stack operations 320, may provide information to the physical layer circuit 310. The information provided to the physical layer circuit 310 can be configured to cause the physical layer circuit 310 to skip decoding a data payload for one or more data blocks received via the communications interface 304.

At 504, the access terminal 300 may receive a data block. For example, the processing circuit 302 may receive one or more data blocks via the communications interface 304. The received data block is typically received by the processing circuit 302 at the physical layer circuit 310 initially.

At step 506, the access terminal 300 can decode the header of the received data block without decoding a data payload for the received data block, in response to the information conveyed from the upper layer. For example, the physical layer circuit 310 can decode the header of the received data block, while bypassing decode of the data payload for the data block in response to the information provided to the physical layer circuit 310 by the upper layer circuit.

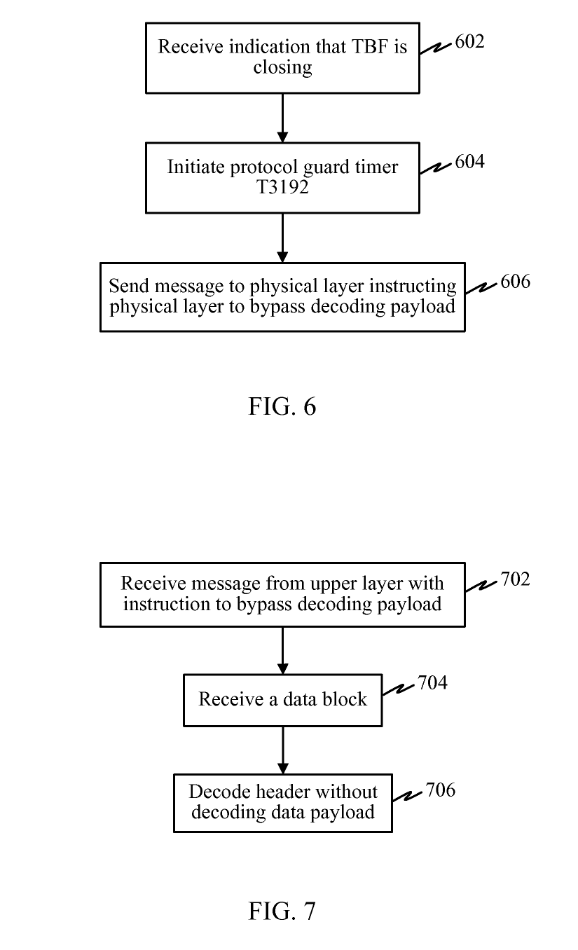

In at least one example of the method 500, the information conveyed by the upper layer to the physical layer at step 502 may include information sent in a message adapted to instruct the physical layer to skip decoding a data payload for data blocks received. In at least one example, the message may be sent in response to a protocol guard timer T3192 discussed above, which may be initiated at the upper layer. FIG. 6 is a flow diagram illustrating an example of an algorithm that may be implemented for such a scenario by an upper layer circuit of the processing circuit 302, such as the data link layer circuit 312 and/or the L3 layer circuit 314, executing the protocol stack operations 320. The upper layer circuit may receive an indication that a TBF is being closed at operation 602. For instance, the upper layer circuit may receive a conventional indication from a network node that a downlink TBF is being closed, such as after the last data block has been successfully sent to the access terminal 300. In response to such an indication, the upper layer circuit may initiate the protocol guard timer T3192 for the designated period of time at operation 604. In addition, the upper layer circuit can send a message to the physical layer circuit 310 instructing the physical layer circuit 310 to bypass decoding a payload for any data block received, at operation 606.

Turning to FIG. 7, a flow diagram is depicted to illustrate one example of an algorithm that may be implemented by the physical layer circuit 310 executing the protocol stack operations 320. The algorithm of FIG. 7 may be implemented in response to the algorithm of FIG. 6. At operation 702, the physical layer circuit 310 may receive a message from the upper layer circuit (e.g., data link layer circuit 312, L3 layer circuit 314) that includes instructions to bypass decoding a payload for data blocks received. At operation 704, the physical layer circuit 310 may receive a data block via the communications interface 304. In response to the received message, the physical layer circuit 310 can decode the header of the received data block, while skipping a decode of the data payload for the received data block, at operation 706. As noted above, the data blocks that the access terminal 300 may receive during a protocol guard timer T3192 include a Poll that is adapted to instruct the access terminal 300 to restart the protocol guard timer T3192. The relevant information in such a Poll message is included in the header of the data block. Therefore, implementing the above algorithms can enable the access terminal 300 to obtain the relevant information during such a protocol guard timer T3192, without needlessly decoding the data payload.

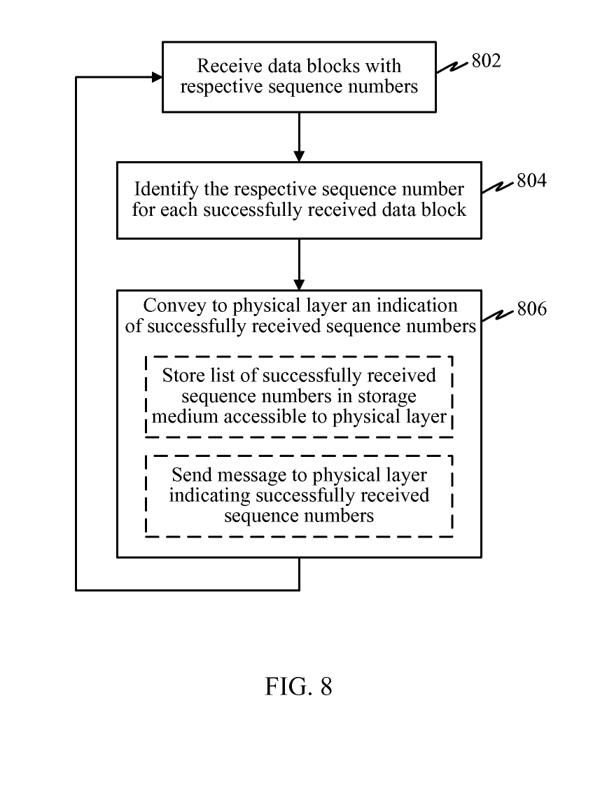

In another example of the method 500, the information conveyed by the upper layer to the physical layer at step 502 may include an indication of sequence numbers associated with data blocks that have been successfully received at the upper layer. FIG. 8 is a flow diagram illustrating an example of an algorithm that may be implemented for such a scenario by an upper layer circuit of the processing circuit 302, such as the data link layer circuit 312 and/or the L3 layer circuit 314, executing the protocol stack operations 320. The upper layer circuit may receive data blocks with respectively associated sequence numbers at operation 802. At operation 804, the upper layer circuit can identify the respective sequence number for each successfully received data. At operation 806, the upper layer circuit can convey to the physical layer circuit 310 an indication of sequence numbers for each successfully received data block.

In one example, the upper layer circuit can convey the indication of successfully received sequence numbers to the physical layer circuit 310 by storing a list of successfully received sequence numbers in a portion or component of the storage medium 306 that is accessible to the physical layer circuit 310. For instance, a data link layer circuit 312 is often adapted to maintain a list of sequence numbers for data blocks that have been successfully received. This list is typically maintained in a memory, such as a component of the storage medium 306, which is associated with the data layer circuit 312. According to an aspect of the present example, the portion or component of the storage medium 306 at which the list is maintained may be a shared memory that both the data link layer circuit 312 and the physical layer circuit 310 are able to access.

In another example, the upper layer circuit can convey the indication of successfully received sequence numbers to the physical layer circuit 310 by sending a message to the physical layer circuit 310 adapted to indicate whether a sequence number has been successfully received. In some examples, the message may include a listing of one or more sequence numbers associated with data blocks that have been successfully received. In some examples, the message may include a listing of one or more sequence numbers associated with data blocks that were not yet successfully received, but are within a range of sequence numbers expected to be received.

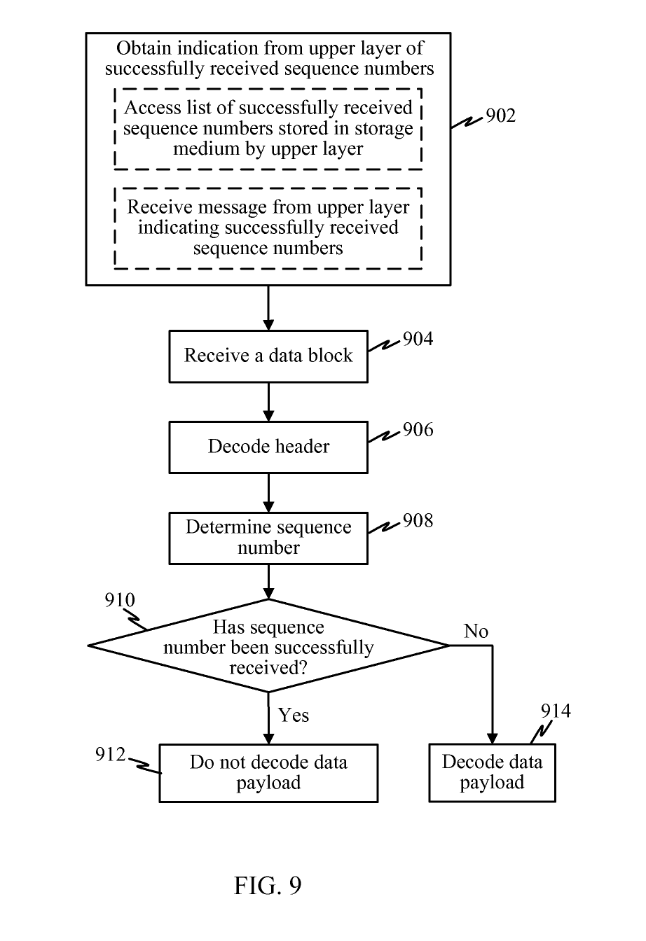

Turning to FIG. 9, a flow diagram is depicted to illustrate one example of an algorithm that may be implemented by the physical layer circuit 310 executing the protocol stack operations 320. The algorithm of FIG. 9 may be implemented in response to the algorithm of FIG. 8. At operation 902, the physical layer circuit 310 may obtain from an upper layer circuit an indication of successfully received sequence numbers. In one example, the physical layer circuit 310 may obtain the indication of successfully received sequence numbers by accessing a list of successfully received sequence numbers stored in a portion or component of the storage medium 306 by the upper layer circuit, as noted above with reference to FIG. 8. In another example, the physical layer circuit 310 may obtain the indication of successfully received sequence numbers by receiving from the upper layer circuit a message adapted to indicate whether a sequence number has been successfully received, as also noted above with reference to FIG. 8.

At operation 904, the physical layer circuit 310 can receive a data block. At operation 906, the physical layer circuit 310 can decode the header of the data block. From the decoded header, the physical layer circuit 310 can determine the sequence number associated with the data block at operation 908.

With the sequence number identified, the physical layer circuit 310 can determine whether the sequence number has already been successfully received at decision diamond 910. This determination may be made by comparing the determined sequence number to a list stored by the upper layer circuit in the storage medium 306, or from a list received from the upper layer circuit.

If the physical layer circuit 310 determines at decision diamond 910 that the data block associated with the sequence number has already been successfully received, then the physical layer circuit 310 can bypass decoding the data payload of the data block at operation 912. On the other hand, if the physical layer circuit 310 determines at decision diamond 910 that the data block associated with the sequence number has not yet been successfully received, then the physical layer circuit 310 can decode the data payload of the data block at operation 914.

While the above discussed aspects, arrangements, and embodiments are discussed with specific details and particularity, one or more of the components, steps, features and/or functions illustrated in FIGS. 1, 2, 3, 4, 5, 6, 7, 8, and/or 9 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, and/or 3 may be configured to perform or employ one or more of the methods, features, parameters, algorithms, and/or steps described in FIGS. 4, 5, 6, 7, 8, and/or 9. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

1. An access terminal, comprising:
a communications interface configured to receive encoded data blocks; and
a processing circuit coupled to the communications interface, the processing circuit configured to implement a protocol stack comprising a physical layer and an upper layer, wherein the processing circuit is configured to:
provide information from the upper layer of the protocol stack to the physical layer of the protocol stack, wherein the information is configured to cause the physical layer to bypass decoding a data payload for one or more data blocks received via the communications interface; and
decode, at the physical layer, a header of a received data block without decoding a data payload for the received data block in response to the information provided from the upper layer.

2. The access terminal of claim 1, wherein the processing circuit configured to provide information from the upper layer to the physical layer comprises the processing circuit configured to: convey a message from the upper layer to the physical layer, wherein the message is configured to instruct the physical layer to bypass decoding a data payload of data blocks received during a period of time.

3. The access terminal of claim 2, wherein the processing circuit is further configured to: initiate a protocol guard timer T3192 at the upper layer; wherein the message is conveyed from the upper layer to the physical layer in response to initiation of the protocol guard timer T3192.

4. The access terminal of claim 1, wherein the processing circuit configured to provide information from the upper layer to the physical layer comprises the processing circuit configured to: provide, from the upper layer, an indication of sequence numbers for data blocks that have been successfully received at the upper layer.

5. The access terminal of claim 4, wherein the processing circuit is configured to: implement the physical layer to decode a header without decoding a data payload for any data block having a sequence number matching a sequence number indicated to have been successfully received at the upper layer.

6. The access terminal of claim 4, further comprising: a storage medium coupled to the processing circuit and accessible by both the upper layer and the physical layer, wherein the processing circuit is configured to provide the indication of sequence numbers for data blocks that have been successfully received at the upper layer by storing a list of successfully received sequence numbers in the storage medium.

7. The access terminal of claim 4, wherein the processing circuit configured to provide the indication of sequence numbers for data blocks that have been successfully received at the upper layer comprises the processing circuit configured to: convey a message from the upper layer to the physical layer, the message including the indication of sequence numbers for data blocks that have been successfully received at the upper layer.

8. The access terminal of claim 1, wherein the upper layer comprises a data link layer of the protocol stack.

9. A method operational on an access terminal, comprising:
conveying information from an upper layer of a protocol stack to a physical layer of the protocol stack, wherein the information is configured to cause the physical layer to bypass decoding a data payload for one or more received data blocks;
receiving a data block; and
decoding at the physical layer a header of the received data block without decoding a data payload for the received data block in response to the information conveyed from the upper layer.

10. The method of claim 9, wherein conveying information from the upper layer of the protocol stack to the physical layer of the protocol stack comprises: conveying the information from a data link layer of the protocol stack to the physical layer of the protocol stack.

11. The method of claim 9, wherein conveying information from the upper layer to the physical layer comprises: sending a message from the upper layer to the physical layer, wherein the message is configured to instruct the physical layer to bypass decoding a data payload of data blocks received during a period of time.

12. The method of claim 11, wherein sending the message from the upper layer to the physical layer comprises: sending the message from the upper layer to the physical layer in response to an initiated protocol guard timer T3192.

13. The method of claim 9, wherein conveying information from the upper layer to the physical layer comprises: conveying an indication of sequence numbers associated with data blocks that have been successfully received at the upper layer.

14. The method of claim 13, further comprising: decoding a header without decoding a data payload when a data block includes a sequence number matching a sequence number indicated to have been successfully received at the upper layer.

15. The method of claim 13, wherein conveying the indication of sequence numbers associated with data blocks that have been successfully received at the upper layer comprises: storing a list of successfully received sequence numbers in a storage medium accessible by the physical layer.

16. The method of claim 13, wherein conveying the indication of sequence numbers associated with data blocks that have been successfully received at the upper layer comprises: sending a message from the upper layer to the physical layer, the message including the indication of sequence numbers for data blocks that have been successfully received at the upper layer.

17. An access terminal, comprising:
means for conveying information from an upper layer of a protocol stack to a physical layer of the protocol stack, wherein the information is configured to cause the physical layer to bypass decoding a data payload for one or more received data blocks; and
means for decoding at the physical layer a header of a received data block without decoding a data payload for the received data block in response to the information conveyed from the upper layer.

18. The access terminal of claim 17, wherein the information conveyed from the upper layer to the physical layer comprises a message sent from the upper layer to the physical layer, the message configured to instruct the physical layer to bypass decoding a data payload of data blocks received.

19. The access terminal of claim 18, wherein the message is sent from the upper layer to the physical layer in response to initiation of a protocol guard timer T3192.

20. The access terminal of claim 17, wherein the information conveyed from the upper layer to the physical layer comprises an indication of sequence numbers associated with data blocks that have been successfully received at the upper layer.

21. The access terminal of claim 20, further comprising: means for decoding a header without decoding a data payload when a data block includes a sequence number matching a sequence number indicated to have been successfully received at the upper layer.

22. The access terminal of claim 20, further comprising: means for storing an indication of successfully received sequence numbers in a storage medium accessible by the physical layer to indicate the sequence numbers associated with data blocks that have been successfully received at the upper layer.

23. The access terminal of claim 20, further comprising: means for sending a message from the upper layer to the physical layer, wherein the message includes the indication of sequence numbers associated with data blocks that have been successfully received at the upper layer.

24. The access terminal of claim 17, wherein the upper layer comprises a data link layer of the protocol stack.

25. A non-transitory processor-readable storage medium, comprising programming for causing a processing circuit to:
provide information from an upper layer of a protocol stack to a physical layer of the protocol stack, wherein the information is configured to cause the physical layer to bypass decoding a data payload for one or more received data blocks; and
decode, at the physical layer, a header of a received data block without decoding a data payload for the received data block in response to the information provided from the upper layer.

26. The processor-readable storage medium of claim 25, wherein the programming is configured to cause a processing circuit to: provide the information from the upper layer to the physical layer by sending a message from the upper layer to the physical layer, wherein the message is configured to instruct the physical layer to bypass decoding a data payload of data blocks received.

27. The processor-readable storage medium of claim 26, wherein the message is sent in response to a protocol guard timer T3192.

28. The processor-readable storage medium of claim 25, wherein the programming is configured to cause a processing circuit to: provide the information from the upper layer to the physical layer by conveying an indication of sequence numbers associated with data blocks that have been successfully received at the upper layer.

29. The processor-readable storage medium of claim 28, wherein the programming is configured to cause a processing circuit to: decode, at the physical layer, a header of a received data block without decoding a data payload for the received data block in response to a sequence number associated with the received data block matching a sequence number indicated to have been successfully received at the upper layer.

30. The processor-readable storage medium of claim 28, wherein the programming is configured to cause a processing circuit to: convey the indication of sequence numbers associated with data blocks that have been successfully received at the upper layer by storing a list of successfully received sequence numbers in a storage medium accessible by the physical layer.
